(19) United States
(12) Patent Application Publication
(10) Pub. No.: US 2007/0265870 A1
(43) Pub. Date: Nov. 15, 2007

(54) METHODS AND SYSTEMS FOR UTILIZING A TIME FACTOR AND/OR ASYMMETRIC USER BEHAVIOR PATTERNS FOR DATA ANALYSIS

(75) Inventors: Xiaodan Song, San Jose, CA (US); Belle L. Tseng, Cupertino, CA (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/537,018

(22) Filed: Sep. 29, 2006

Related U.S. Application Data
(60) Provisional application No. 60/745,121, filed on Apr. 19, 2006.

(51) Int. Cl. G06Q 10/00; G06Q 30/00

(52) U.S. Cl. 705/1

(57) ABSTRACT

Methods and systems for data mining and analysis that may be used for capturing user/entity behavior, providing influence filtering and/or providing recommendations. One particular use may be for providing, among other things, personalized recommendations. The methods and systems may include generating an influence network. The influence network may include a user's adoption behavior of items. The influence network may further include temporal aspects of information flow or diffusion of information through the network. The influence network may also include adoption time(s) of one or more item(s) between users/entities. Further, the influence network may include asymmetric user/entity adoption behavior. Methods and systems of influence filtering are provided that include generating asymmetric relationship(s) between users and providing a filtering module utilizing the asymmetric relationship(s) between user/entity.

This application claims the benefit of U.S. Provisional Application No. 60/745,121 filed Apr. 19, 2006, the entire disclosure of which is hereby incorporated by reference as if set forth fully herein.

This disclosure may contain information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND

1. Field of the Invention

The present invention relates to the field of data mining and analysis and, more specifically, to methods and systems relating to data analysis of data relationships that may be used for, among other things, providing recommendation(s) to user(s).

2. Description of Related Art

Data mining and analysis of data compilations, including statistical analysis of relationships in the data and prediction of future trend analysis, is an area of wide application. For example, organizations often would like to provide recommendations to a person or group based on their likely interest in various item(s). The recommendations may be personalized to the user. For example, there are presently a number of methods and systems that provide collaborative recommendations that group individuals or groups together based on prior activities and their related behavioral similarity. Some examples include those described in U.S. Pat. No. 6,266,649, U.S. Pat. No. 6,912,505, and U.S. Pat. No. 6,853,982, U.S. Pat. No. 6,999,962, U.S. Pat. No. 6,912,505, and U.S. Pat. No. 5,704,017, and U.S. Pat. No. 6,655,963. One exemplary recommender system is based on Collaborative Filtering (CF), which has been used to simulate or automate the “word-of-mouth” process involved in people or organizations giving recommendations to friends and associates.

However, prior systems and methods lack certain useful capabilities. For example, prior recommendation systems and methods such as CF systems and methods lack the ability to recognize the temporal aspects of how information propagates or diffuses over time through a social network(s) that may include families, friends, organization(s), professional societies, consumer group(s), countries, and/or the world. Further, the prior recommendation systems and methods do not take into consideration the asymmetric aspects of the influence that two entities, people, and/or organizations may have on one another's decisions to adopt a given item, technology, approach, etc. Similarly, the prior recommendation systems and methods do not specifically take into consideration the multiple paths which information can flow and diffusion in social networks for sharing of information within families, friends, organization(s), professional societies, consumer group(s), countries, and/or the world. Further, the prior recommendation systems and methods do not necessarily take into consideration that the accuracy of recommendation(s) may be topic sensitive.

Therefore, there is a need for recommendation systems and methods that can provide more accurate and valuable recommendations based on temporal aspects of information diffusion, asymmetric aspects of the influence between entities, and/or multiple paths of information diffusion.

### SUMMARY

The present invention is directed generally to providing systems and methods for data analysis. More specifically, embodiments may include systems and methods relating to analyzing data to capture user/entity behavior, providing influence filtering and/or providing recommendations using temporal and/or asymmetric relationships between users/entities. The invention may be a computer implemented invention.

Some embodiments may include, for example, system(s) and method(s) in which temporal aspects of how information propagates or diffuses over time through a network or data, such as a social network(s) that may include families, friends, organization(s), professional societies, consumer group(s), countries, and/or the world is comprehended. Further, some embodiments may also include, for example, system(s) and method(s) that comprehend the asymmetric aspects of the influence that two or more entities, people, and/or organizations may have on one another's decisions to adopt a given item, technology, approach, etc. Still some embodiments may further include, for example, system(s) and method(s) that take into consideration the multiple paths which information can flow and diffusion in social networks for sharing of information within families, friends, organization(s), professional societies, consumer group(s), countries, and/or the world. Some embodiments may further include, for example, system(s) and method(s) that take into consideration the topic sensitive nature of some areas where the use of the data, such as making recommendations, differs for each category of items. One or more embodiments may be directed particularly to providing recommendations from data analyzed, for example, providing personalized recommendations.

In at least one embodiment, the system(s) and method(s) may include generating an influence network including users/entities adoption behavior for items. The influence network may include a factor of time, for example, adoption times of items between users. Further, information propagation through the influence network may be identified. The influence network in various embodiments may be an Early Adoption Based Information Flow (EABIF) network and may comprehend asymmetric users' adoption behavior. The influence network in various embodiments may include a Topic-sensitive Early Adoption Based Information Flow (TEABIF) network and may comprehend the topic sensitive nature of information flow for particular categories of items.

In at least one embodiment, the system(s) and method(s) may include identifying and/or generating asymmetric relationship(s) between users/entities and/or providing a filtering module utilizing the asymmetric relationship(s) between users/entities. The embodiment(s) may utilize influence filtering for ranking users and/or items. The asymmetric relationship between users/entities may include user/entity asymmetric behavior for the adoption of item(s). One or more embodiment(s) may also include influence filtering utilizing category of items as a criteria.

Still further aspects included for various embodiments will be apparent to one skilled in the art based on the study of the following disclosure and the accompanying drawings thereto.

### BRIEF DESCRIPTION OF THE DRAWINGS

The utility, objects, features and advantages of the invention will be readily appreciated and understood from consideration of the following detailed description of the embodiments of this invention, when taken with the accompanying drawings, in which same numbered elements are identical and:

FIG. 1 is an exemplary graph showing a diffusion of innovation theory, according to at least one embodiment;

FIGS. 2a and 2b are exemplary intuitive representation of recommendation(s) driven by information flow, according to at least one embodiment;

FIG. 3 is an exemplary illustration of how adoption patterns affect recommendations, according to at least one embodiment;

FIG. 4 is an exemplary illustration of information flow, according to at least one embodiment;

FIG. 5 is an exemplary overview of an information propagation driven recommendation scheme based on early adoption, according to at least one embodiment;

FIG. 6 is an exemplary overview of an information propagation driven recommendation scheme based on topic-sensitive early adoption, according to at least one embodiment;

FIG. 7 is an exemplary overview of an information propagation driven recommendation scheme based on both general early adoption and topic-sensitive early adoption, according to at least one embodiment;

FIG. 8 is an exemplary method for providing recommendation(s) based on temporal behavior patterns and/or asymmetric influence(s), according to at least one embodiment;

FIG. 9 is an exemplary method for providing recommendation(s) based on temporal behavior patterns and/or asymmetric influence(s), according to at least one embodiment;

FIG. 10 is an exemplary scheme overview for a recommendation system(s) and method(s), according to at least one embodiment;

FIG. 11 is an exemplary adoption matrix, according to at least one embodiment;

FIG. 12 is an exemplary illustration of information flow through multiple paths, according to at least one embodiment;

FIGS. 13a-13d are exemplary comparison precision and recall for EABIF and TEABIF to baseline collaborative filtering results, according to at least one embodiment; and

FIGS. 14a-14d exemplary comparison precision and recall for EABIF and TEABIF relative to collaborative filtering results with variation to the number of propagation steps, according to at least one embodiment.

FIG. 15 is an exemplary functional block diagram of a computing device, according to at least one embodiment;

FIG. 16 is an exemplary functional block diagram illustrating a network, according to at least one embodiment;

### DETAILED DESCRIPTION

The present invention is directed generally to systems and methods for data analysis. More specifically, embodiments may include systems and methods relating to analyzing data so as to capture user/entity behavior, providing influence filtering and/or providing recommendations. Such embodiments may include, for example, system(s) and method(s) in which temporal aspects of how information propagates or diffuses over time through a network or data, such as a social network(s) that may include families, friends, organization(s), professional societies, consumer group(s), countries, and/or the world is comprehended.

Some of the exemplary contributions of the present invention includes: (1) leveraging users adoption patterns for providing recommendations, e.g., personalized recommendation; (2) providing topic-sensitive model based on the observation that adoption is typically category specific; and (3) providing three information propagation models based on irreducible Markov chains to guarantee convergence. Other contributions are also provided and will be appreciated by one skilled in the art.

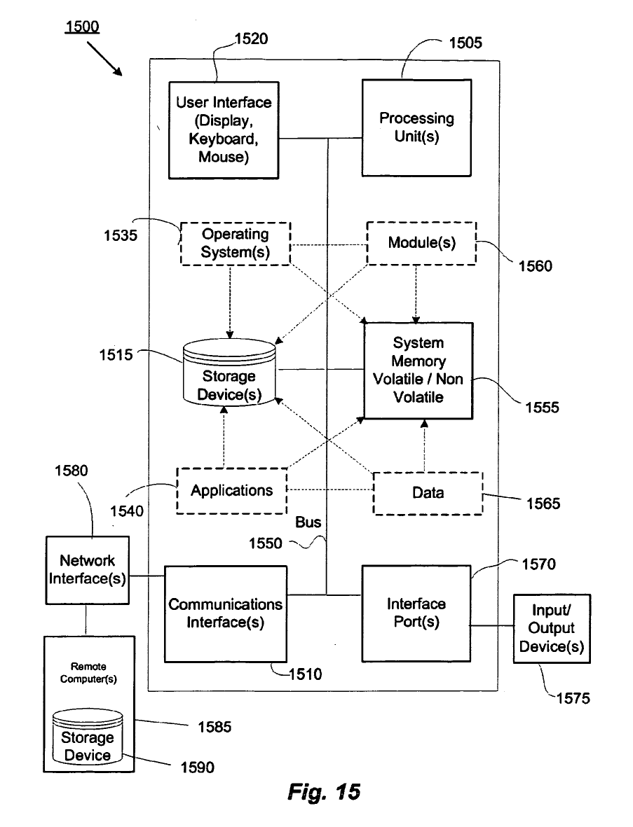

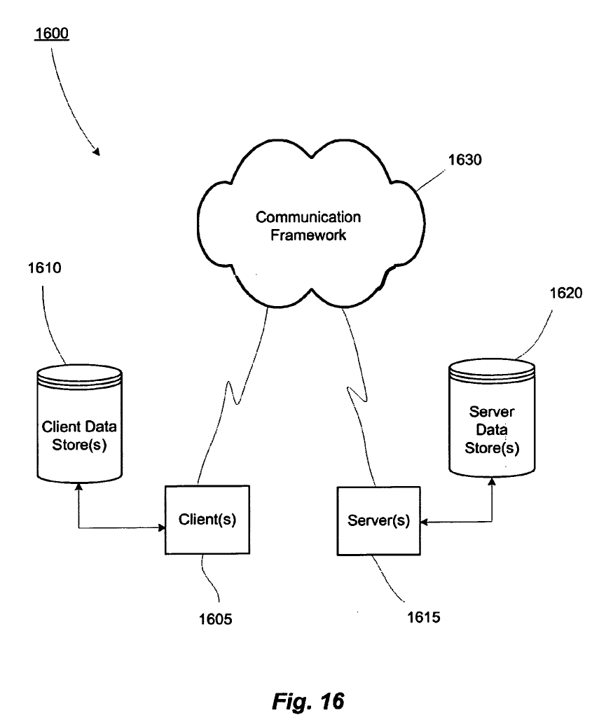

In at least one embodiment, the system(s) and method(s) provided herein may be implemented using a computing device, and may be operational on one or more computer(s) within a network. Details of exemplary computing device(s) and network(s) are described in some detail in, FIG. 15 and FIG. 16. Prior reference to those examples may prove helpful in developing a better appreciation for various details of the invention.

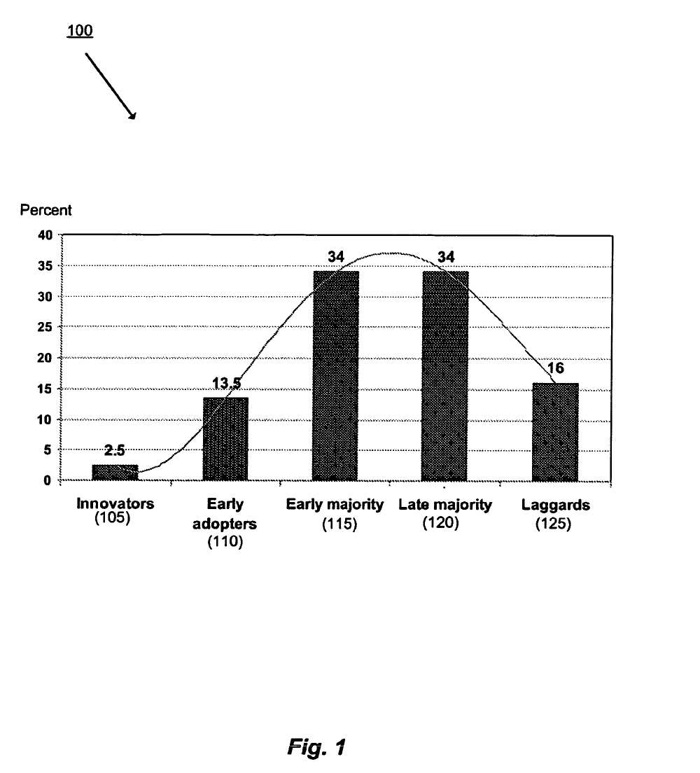

Referring now to FIG. 1, before going into the details of this invention, we state the challenge which we would like to solve with this invention. FIG. 1 illustrates a Diffusion of Innovations Theory, showing a graph. The graph has an x-axis that represents relative time when people/entities would adopt a new item and a y-axis that represents percentage of all people/entities that adopt a new item. We also assume all the users in the parallelogram bars in the graph have similar interests. This theory proposes that adoption of any new innovation or idea is adopted at different times by different people/entities. For example, a new innovation, idea, product, services, etc., may first in time be adopted by those people/entities that are considered to be innovators 105. However, the number of people/entities who are actually considered to be Innovators 105 or first adopters, comprising, for example, only approximately 2.5% of all adopters. Next in time, a second grouping of people/entities, referred to as Early Adopters 110 makes up, for example, approximately 13.5% of all adopters. Next in time a third grouping of people/entities, referred to as an Early Majority 115, that makes up, for example, approximately 34% of all adopters. Next in time a fourth grouping of people/entities, referred to as a Late Majority 120, that makes up, for example, another approximately 34% of all adopters. Finally, last in time a fifth grouping of people/entities, referred to as Laggards 125, that makes up, for example, approximately another 16% of all adopters (total should equal 100% of all adopters). Each adopter's willingness and ability to adopt an innovation would depend on their awareness, interests, personality and so on. Based on this theory and graph, one can understand that the diffusion of information that may result in the ultimate adoption of a new idea, technology, etc., can be understood to be flowing from earlier adopters to later adopters.

Applying the Diffusion of Innovation Theory will at times result in different results than traditional collaborative filtering (CF) methods, thus identifying which people/entities will adopt a new innovation, idea, or technology based on which person/entity is prompting the analysis. Intuitively, if a person/entity that acts as an Innovator 105 (adopts ideas first) has adopted a new innovation, idea, or technology, then it may be generally inferred that other classes of people/entities shown in the graph (Early Adopter 110, Early Majority 115, Late Majority 120, and Laggard 125) would adopt it later, because the persons/entities have similar tastes. In the case of traditional collaborative filtering, it may also be inferred that most likely the other classes of people will also adopt this item (without regard to the Diffusion of Innovation Theory shown in FIG. 1). On the other hand, what other classes of persons/entities are likely to adopt a new item if one of the other classes of people/entities adopts and item, if a Laggard 125 adopts an item? Based on CF, it would be inferred that all the other classes of people/entities would adopt the new item due to the assumption of symmetry. However, based on the Diffusion of Innovation Theory suggests asymmetry of adoption; so if you look at the nature of a person/entity that typically would be classified as an Innovator 105, they are less likely to follow a Laggard 125 to adopt anything. In fact, the Innovator 105 has probably already adopted the items at an earlier time. Therefore, the Diffusion of Innovation Theory suggests an asymmetric influence or probability of information flow, influence and/or adoption habits. The results are often driven by the information flow, which is often determined by influence of one person/entity on others, and visa-versa.

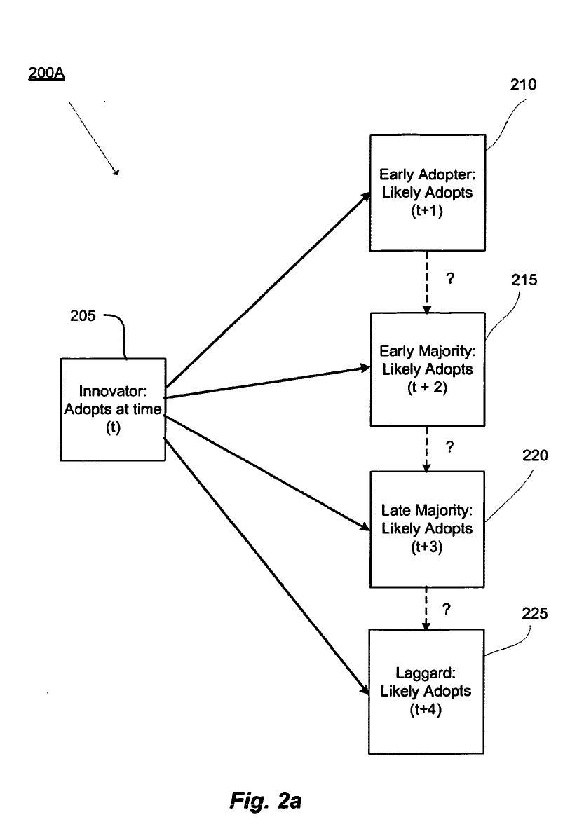

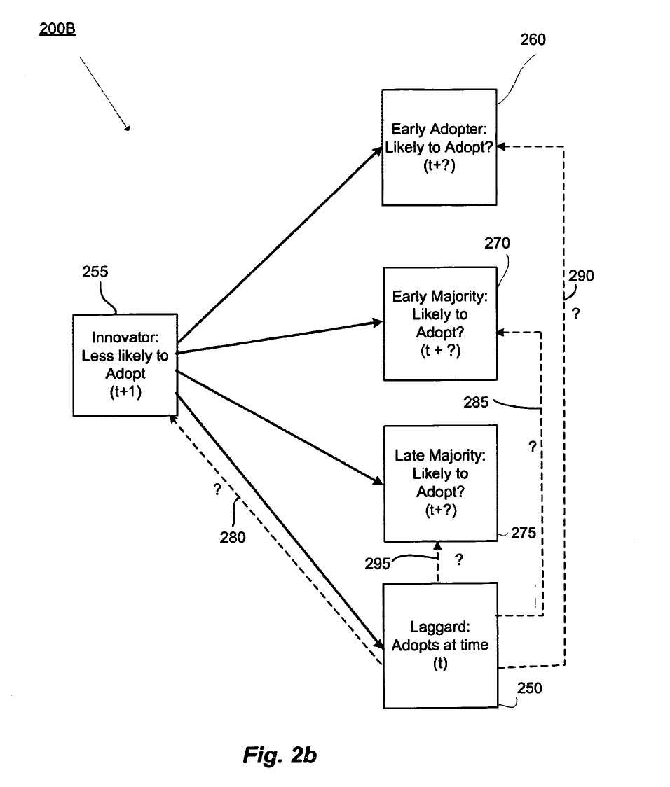

Referring now to FIGS. 2a and 2b, a first example 200A of utilizing the Diffusion of Innovation Theory is provided. In this scenario an Innovator(s) 205 adopts at time t. As described above, once the Innovator(s) 205 has adopted an idea, product, services, document, item, etc., the Early Adopter(s) 210 will likely adopt at time t+1, the Early Majority(ies) 215 will likely adopt at time t+2, the Late Majority(ies) 220 will likely adopt at time t+3, and the Laggard(s) 225 will likely adopt at time t+4. Although, it is not certain whether the adoption by any one of the Early Majority(ies) 215, Late Majority(ies) 220, and/or Laggard(s) 225 will result from influence directly from the Innovator 205 or from one of the other entities that adopts earlier (as indicated by the dashed arrows with “?” next to them). In any case, intuitively all classes are likely to adopt a new idea, item, etc., at some time t+n after an Innovator(s) 205.

On the other hand, the Theory of Diffusion also suggests that one of the later adopting people/entity is not as likely to influence those people/entity that typically adopt earlier. Referring to FIG. 2b., an illustration 200B is provided to show that later adopters are less likely to influence the earlier adopters. In this scenario, a Laggard 250 is assumed to adopt an idea, product, services, document, item, etc. at time t. However, in this scenario it is much less likely that the Innovator 255 will adopt the idea (etc.) at time t+1, as indicated by the dotted line 280 referenced with a question mark (?). In fact, it is possible that the Innovator 255 will never follow or be later in time at adopting something that has been adopted by a Laggard 250. So from an influence or referral perspective, it would be almost useless for a system(s) or method(s) to propose an Innovator 255 the adoption of any idea (etc.) that was earlier adopted by a Laggard(s) 250. The same might be said of proposing to the Early Adopter 260, Early Majority 270, and/or Late Majority 275 the adoption of any idea (etc.) that was earlier adopted by a Laggard(s) 250 (as denoted by the dashed arrows 285, 290, and 295). Although, one might expect that adoption by the Laggard 250 would probably be more influential on the Late Majority 275, because of their closeness of adoption habits (i.e., generally both of these classes are later at adopting than the other classes of adopters).

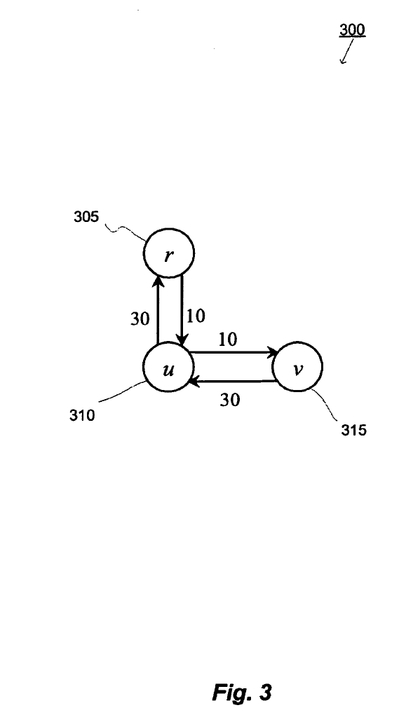

Referring now to FIG. 3, another exemplary illustration of how adoption patterns affect recommendations is provided, according to at least one embodiment, will now be explained. This example gives another intuitive description of how leveraging users' adoption patterns will help when providing, for example, system(s) and method(s) for recommendations. In this example, there are, for example, three users in the universe: u 310, v 315, and r 305. From the historical data, we learn that User u 310 and User v 315 have accessed, for example, 40 items in common. We also learn that, for example, User u 310 and User r 315 have accessed 40 items in common. Thus, using for example Cosine Similarity, the cosine similarities between u 310 and v 315, and u 310 and r 305 are the same, based on their previous accessing or adoption behaviors. When u 310 adopts an item D, then a traditional Collaborative Filtering (CF) method based on Cosine Similarity will equally recommend this item D to r 305 and v 315. Similarly, when r 305 or v 315 accesses or adopts an item, this item will also be recommended to u 310 with an equal weight. However, if we compare, for example, their respective adoption timestamps, among 40 items, u 310 may have accessed 10 of them earlier than v 315, and 30 of them later than v 315. On the other side, u 310 may have accessed 30 of them earlier than r 305, and 10 of them later than v 315. These two types of adoption patterns are quite different, which basically tells us that the information “flow” from u 310 to r 305 is more likely than from u 310 to v 315.

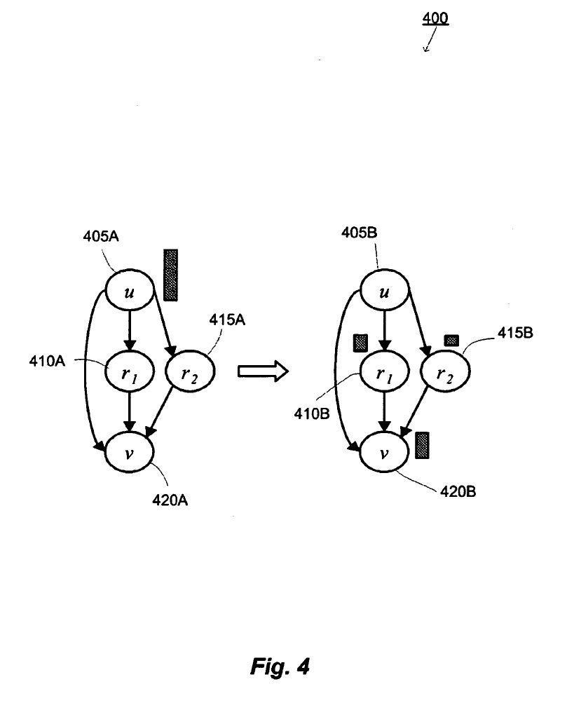

Referring now to FIG. 4, an exemplary illustration of information flow, according to at least one embodiment, will be described. First, we provide exemplary social networks 400 for the early-to-late adoption patterns that may be suggested by an information or innovation diffusion theory. On the left side of FIG. 4, the exemplary network may show an initial exemplary state. On the right side of FIG. 4, the exemplary network may show a final exemplary state. These exemplary network(s) may describe how likely the information will flow from one user/entity to another user/entity. The example shown in FIG. 6 includes a User u 405A (network node) that may adopt information in the initial state. It is possible that this information may be transferred to the other nodes (e.g., v 420A) in the network through multiple possible paths; directly from u 405A, through node r₁ 410A and/or through node r₂ 415A. Given the propagation probability of each path, it may be possible to get the final information receiving probabilities of the nodes (illustrated as the bars in FIG. 4). Note that if this is used in, for example, a recommendation process, the users may be ranked according to which user(s)/person(s)/entity(ies) are more likely to adopt an item, idea, etc., after u 405A rather than the exact probabilities that these users will adopt. It may be assumed that the information flow is similar to the water flow, in which information is not duplicated through propagation. Although this assumption may be somewhat artificial, it may provide an ergodic Markov chain property (e.g., irreducible) that may guarantee convergence and simplifies the calculation of the final-state probabilities, while helping to provide the rank of users. As a result, the final state on the right shows a ranking of probabilities that has the user/entity of node v 420B most likely to adopt, node r₁ 410B the second most likely to adopt, and node r₂ 415A the least likely to adopt. Thus, the system(s) and method(s) of the present invention may be implemented and executed efficiently.

Therefore, to leverage the asymmetric influence between early adopter(s) and later adopter(s), an exemplary system and method scheme for providing a recommendation, such as a personalized recommendation, will be discussed. The scheme driven by information flow. Instead of posing the typical CF question: “how would user X adopt item A when user Y with similar tastes adopts item A?” the present invention addresses the problem differently by addressing the question: “given that user X adopts item A, who would be the most likely next user/entity to adopt item A among users/entities of similar taste?” Based on this, information flow is modeled to flow from earlier adopters to later adopters.

The fact that two users/entities may access or purchase the same item sequentially is modeled as an information flow process: the information is flowing from early adopters to late adopters. The present invention does not need to explicitly explore how or by what means the early adopter influences the late adopter. There may be existing social network connections between two persons/users/entities. The two persons/ users/entities may have habits of watching the same TV channel, one in the morning and one in the evening, that may be showing the same advertisement. Regardless, as long as there are consistent time-based user access patterns, then the appearance of the early adopter accessing an item indicates that a related later adopter is very likely to access/adopt the item soon. On the other hand, the early adopter may not be interested in the items that the late adopter adopts or accesses. This temporal aspect of adoption and/or the asymmetric adoption patterns are particularly helpful in determining whether, for example, a recommendation should be made to a particular user/entity. As a result, the present invention has been proven through experiments to provide better recommendations (as will be described in more detail below).

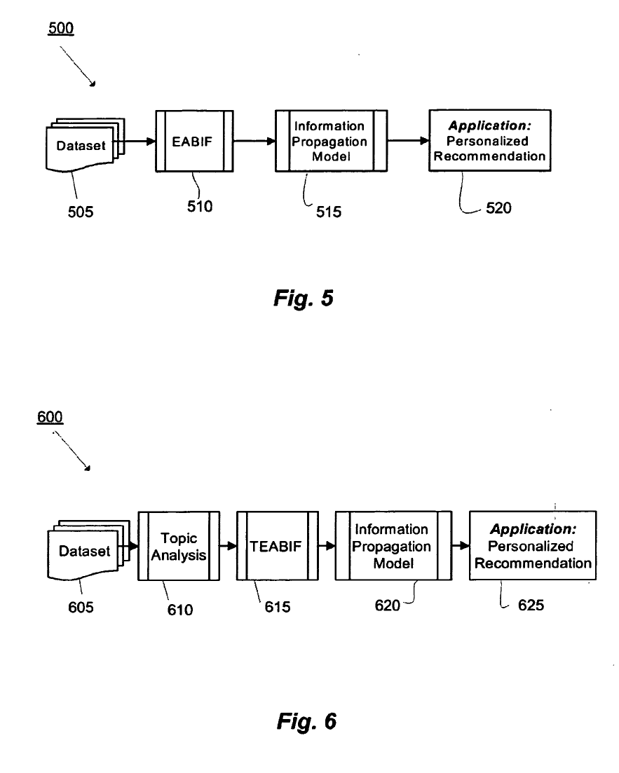

Referring to FIG. 5, an exemplary overview of an information propagation driven recommendation scheme based on early adoption, according to at least one embodiment, is provided. Starting from the dataset 505, we may provide a first module built from an early adoption based information flow (EABIF) network 510, to model the uneven influence between users. The EABIF network 510 may be, for example, a weighted directed network that may be based on pair-wise comparisons to describe how likely each user/entity may make adoptions earlier than the other user(s)/entity(ies). In this example, each user/entity may be modeled as a node (state) in a Markov chain model. Then a second module may use modeling for how the information propagates through the network using an information propagation model 515, it may estimate if a node (person/entity) obtains the information, who will most likely be the follower, and make personalized recommendations 520. One exemplary information propagation model may model information flow behavior of a node by using ergodic Markov chains (e.g., irreducible), in which all states are reachable from all other states (i.e., all states communicate), so that the convergence may be guaranteed. This approach may be applied to either user based (e.g., clustering based on users' characteristics) and/or items based (e.g., clustering based on item(s) selection) analysis. This is analogous to the two types of Collaborative Filtering, user-based and item-based.

Although the EABIF 510 may provide excellent results for some data types and circumstances, adoption patterns are often category-specific (e.g. categories may include books, movies, cars, clothes, written articles, fashion, technology products, etc.). Referring to FIG. 6, another exemplary approach for providing recommendations may be using a module that is a topic-sensitive early adoption based information flow (TEABIF) network 615. People often have different behavior patterns for different categories of items: e.g., an early adopter of fashion may not be an early adopter of technology. Thus, a topic-sensitive information flow network(s) may be more accurate for various types of recommendations. The basic idea is that people may tend to get the information from certain categories earlier or act on information about certain categories earlier than others, while for some other categories, they may not be so eager to obtain or act on the information. Thus to get the more consistent and/or accurate early/late behavior patterns, the information in a dataset 605 (e.g., documents) may first be clustered into the latent categories using Topic analysis 610. Then a TEABIF 615 network(s) may be built based on how likely one user/entity accesses the items (e.g., documents) regarding a certain category earlier or later than other user(s)/entity(s). This may be achieved by using, for example, a Latent Dirichlet Allocation process as explained in more detail below. Then by modeling how the information propagates through the network using an information propagation model 620, which may estimate if a node (person/entity) obtains the information, who will most likely be the follower, and make personalized recommendations 625. Again, one exemplary information propagation model may model information flow behavior of a node by using ergodic Markov chains (e.g., irreducible), in which all states are reachable from all other states (i.e., all states communicate), so that the convergence may be guaranteed. This approach may also be applied to either user based (e.g., clustering based on users' characteristics) and/or items based (e.g., clustering based on item(s) selection) analysis.

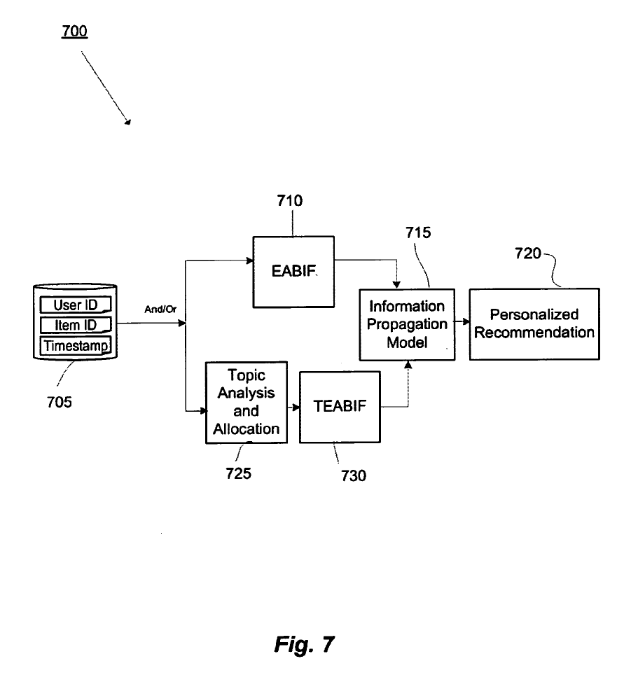

Referring now to FIG. 7, an exemplary overview of an information propagation driven recommendation scheme 700 based on both general early adoption and topic-sensitive early adoption, according to at least one embodiment, is provided. In this example, the dataset 705 may include, for example, a user ID, item ID and timestamp. The scheme includes two possible data assessments using an EABIF module 910 and/or TEABIF module 730. In the case of using TEABIF module 730, the data is analyzed and allocated/segregated/clustered into various categories, e.g., category 1, category 2, category 3, etc. Then networks are constructed based on the particular categories to determine how likely each user/entity is to adopt an item earlier or later than other user(s)/entity(ies). As noted, in this embodiment the EABIF module 710 or the TEABIF module 730 may be selected, or they both may be selected and utilized in determining a recommendation. In any case, modeling how the information propagates through the network may be conducted using an information propagation module 715, which may model and estimate if a node (person/entity) obtains the information, who will most likely be the follower, and make personalized recommendations 720. Again, one exemplary information propagation model may model information flow behavior of a node by using ergodic Markov chains (e.g., irreducible), in which all states are reachable from all other states (i.e., all states communicate), so that the convergence may be guaranteed.

In these examples, personalized recommendation may be analyzed as one application of the invention that addresses the question of “if one user or multiple users access an item, who else will likely follow these early adopters and access this item next?” In a social network, this process is similar to when one node is triggered, then subsequently which other nodes in the network will also be triggered. Thus, FIGS. 5, 6, and 7 help to illustrate the overall scheme/structure of the invention as applied to providing recommendations, for example, personalized recommendations driven by an information flow scheme.

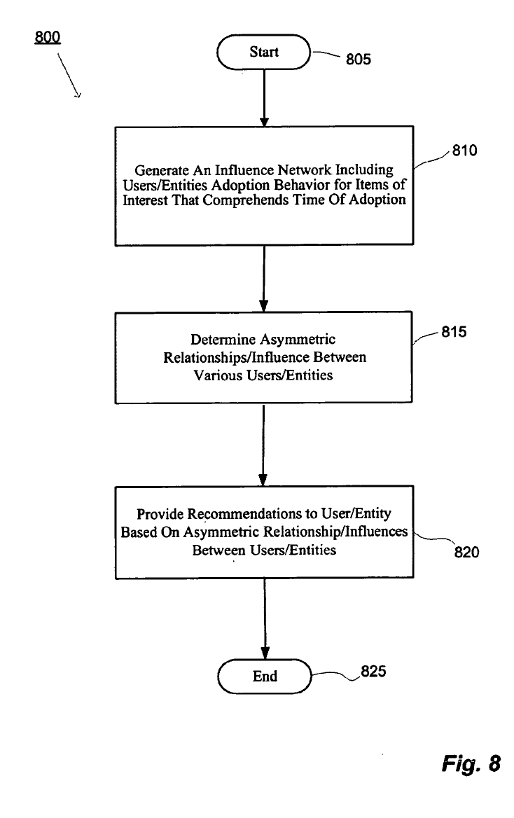

Referring to FIG. 8, an exemplary method or process 800 for providing recommendation(s) based on temporal asymmetric influence(s), according to at least one embodiment, is provided. This method gives a general method or process for the present invention when used in the application of providing recommendations. First, the process starts at step 805 and then at step 810 the process may generate an influence network including users/entities adoption behavior for items of interest that comprehends time of adoption. At step 815, the process may determine asymmetric relationships/influence/behavior between various users/entities. At step 820, the process may provide recommendations to users based on the asymmetric relationship/influence/behavior between users. Of course, in alternative applications of the present invention, the system(s) and method(s) may provide something other than a recommendation. At step 825, the process may end.

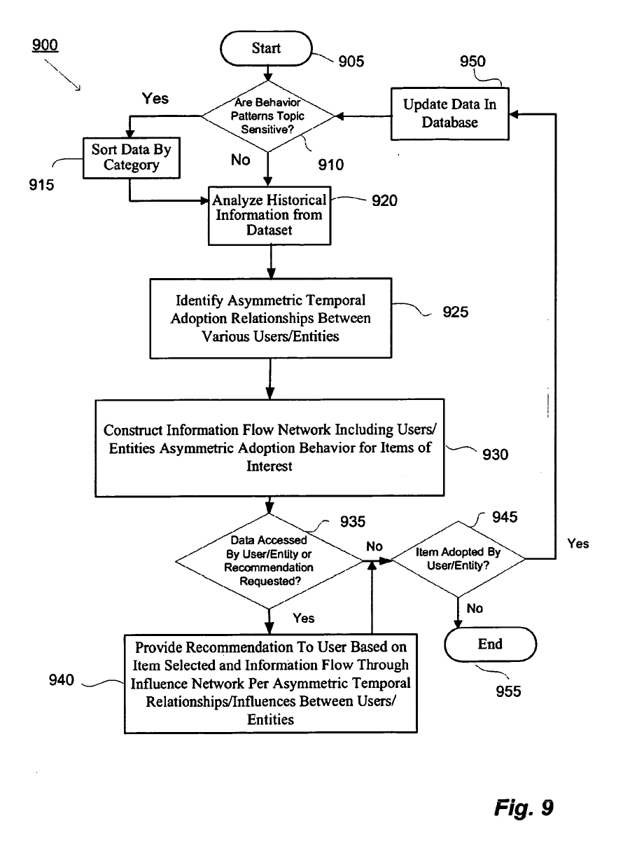

Referring now to FIG. 9, an exemplary method for providing recommendation(s) based on temporal and/or asymmetric influence(s), according to at least one embodiment, is provided. At step 905, the process may start. Next, at step 910, a determination may be made as to whether the behavior patterns are topic sensitive. If the behavior patterns are topic sensitive, then at step 915 the data is sorted by category, and then on to step 920. If the behavior patterns are not topic sensitive, the process may simply goes to step 920. At step 920, the historical data in one or more data set(s) is analyzed. Then, at step 925, asymmetric and/or temporal adoption relationships or behavior between various users/entities may be identified. Next, at step 930, an information flow network may be constructed and may include asymmetric adoption behavior of users/entities for items of interest. Then, at step 935, it is determined whether data has been accessed by a user/entity or a recommendation has been requested. If so, then at step 940, the process may provide a recommendation to a user/entity base on the item selected and the information flow through the influence network(s) per asymmetric and/or temporal relationships/influences between users/entities included in the network. At step 945, it may be determined if an item has been adopted by a user/entity. If the data was not accessed by a user/entity and no recommendation was requested at step 935, the process may monitor to see if there have been any changes to the data at step 945. If there has been changes to the data or a user/entity has adopted an item, at step 950 the data in the database may be updated to reflect the adoption, and the process will continue. If an item has not been adopted by a user/entity at step 945, then the process may end at step 955.

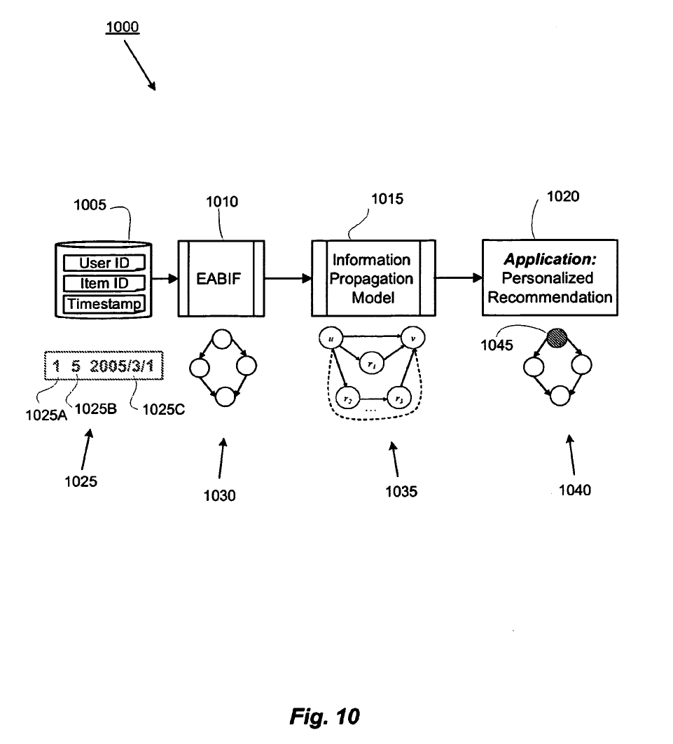

Referring now to FIG. 10, an exemplary scheme overview 1000 for one of the aforementioned recommendation system(s) and method(s), according to at least one embodiment, is illustrated. In this overview, an EABIF system and method is used as an example. The exemplary system and method used here for explanation purposes is shown as a block diagram and may include a database 1005 that may be interfaced with an EABIF 1010. The EABIF 1010 may provide information to an Information Propagation Model 1015. These components may be used in at least one application, to generate a recommendation, for example, a personalized recommendation 1020. Of course, other applications are possible. Below each of the respective blocks in the block diagram, fundamental structures are provide to give examples of how one or more embodiments of the invention may be implemented. For example, below the database or data set 1005, an exemplary data identification structure 1025 is shown. In this case, the data identification structure may include a user ID 1025A that is shown here to be a “1”, an item ID 1025B that is shown here to be a “5”, and a timestamp 1025C that is shown here to be “2005/3/1”. Below the EABIF 1010, a simple Markov chain model 1030 is shown as one of the possible ways to implement the EABIF 1010. Below the Information Propagation Model 1015, a multi-node information flow network 1035 that has information flowing through multiple paths is shown. Finally, in the particular application of providing recommendation(s) 1020, a simple Markov chain model 1040 is shown that illustrates an active user/entity 1045 adopting an item and the processing of that information to determine which other inactive user/entity will likely adopt or not adopt the item. Particular implementation of these and other approaches will be described in more detail below.

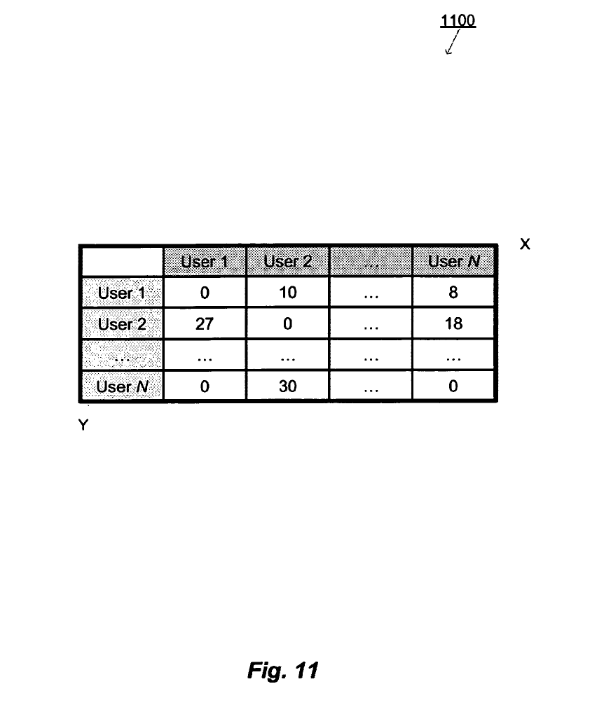

Now an exemplary approach for providing an EABIF will be described. Referring now to FIG. 11, an exemplary adoption matrix, according to at least one embodiment, is provided to help describe the EABIF and TEABIF in more detail. The early adoption matrix may be used to represent the adoption patterns. Then an early adoption based information flow network may be generated as a Markov chain which may be used for, in one application, providing recommendations. To generate the Early Adoption Matrix shown in FIG. 11, there are assumed to be N users/entities (i.e., User 1 . . . User N) and M items (e.g., technical documents, movies, etc.). Given the detailed log information of each user, which may include a timestamp for each adoption, for each pair of users/entities, their respective timestamps of adopting the same items may be compared, and a record may be made of how many items one user adopts earlier than the other, and this information may be placed into an early adoption matrix. As shown in the adoption matrix of FIG. 11, the value in each unit represents how many items user (in rows) accessed earlier than user (in columns). For example, the User 1 row and User 2 column has a 10 in it, indicating the number of times User 1 adopted earlier than User 2. Then, the matrix may be represented in a graph using a weighted directed graph G(n,l), where each node n corresponds to a user and l represents the non-negative weight on each edge. Having an edge with weight l_{u,v} among the items that u and v accessed in common, l_{u,v} of these items were accessed by u earlier than v. For ease of description, a missing edge from u to v may be represented as an edge with zero weight. An edge (u,v) with l_{u,v}=0 means that among the common items that u and v adopt, u always adopts them later than v. Note that for any u and v, the sum of l_{u,v} and l_{u,v} equals the total number of items adopted by u and v. A large value of l_{u,v} relative to l_{u,v} indicate that in most cases, User u adopts the items earlier than User v.

The transition probability may be determined using the aforementioned information. In various embodiments, the adoption graph may be modeled as an ergodic Markov chain with primitive transition probability matrix to guarantee the convergence of the exponentiation of the matrix. One exemplary ergodic Markov chain that may be used in the present invention is shown as used by PageRank and illustrated in S. Brin and L. Page. The anatomy of a large-scale hypertextual web search engine, Computer Networks, 30(1-7):107{117, 1998 and A. N. Langville and C. D. Meyer. Deeper inside PageRank, Internet Mathematics, 1(3):335-400, 2004, hereby incorporated by reference. To study the early/late adoption relationship between users/entities, regarding an item, each user/entity may be defined as either active (adopted the item) or inactive (have not adopted the item). For active mode, a consequential mode may be defined according to the time they make the adoptions. If User u initiates the adoption behavior, his/her mode may be defined as active, User v follows u to access the same item, then his/her mode may be defined as active after u (af ᵥ).

According to the Bayesian rule:

$$\begin{matrix}P \text{(} v = {af}_{u} \vert u = a ) = \frac{P ( v = {af}_{u} , u = a )}{{\sum }_{r} P ( r = {af}_{u} , u = a )} \\ = \frac{{l}_{u , v}}{{\sum }_{r} {l}_{r , v}}\end{matrix} \qquad ( 1 )$$

where P(v=afᵤ|u=a) represents the probability that given u obtains the information, how likely v will adopt the information after u among all the users. Then the normalized probability may serve as the transition probability in a Markov chain F, with F_{u,v}=P(v=afᵤ|u=a) as the transition probability of information flowing from u to v.

To have a workable model, it may be necessary to make some adjustments to the Markov chain model. When a Markov chain is ergodic, the stationary distribution of its Markov matrix is guaranteed to exist. To achieve this ergodic Markov chain, the first problem of solely using the adoption patterns to generate the transition probability matrix is that some rows of the matrix contain all zeroes. This occurs whenever one user/entity did not adopt any items earlier than the other user/entity. Thus, F is not stochastic. A matrix F is stochastic if all F_{u,v} are non-negative and

$${\sum }_{v} {F}_{u , v} = 1.$$

### The nodes which do not satisfy

$${\sum }_{v} {F}_{u , v} = 1$$

are called dangling nodes. One solution may be to do something similar to what PageRank does, so we may apply the remedy to replace all zero rows, O^{T} with

$$\frac{1}{N} {e}^{T} ,$$

where e^{T} is the row vector of all ones. The revised transition probability matrix called F̅ is

$${\overline{F}}_{u , v} = \{ \begin{matrix} P ( v = {af}_{u} \vert u = a ) & if {\sum }_{v} {\overline{F}}_{u , v} \neq 0 \\ \frac{1}{N} & else\end{matrix} \qquad ( 2 )$$

Another adjustment to make a Markov chain ergodic may be to consider the transition probability matrix as a primitive matrix:

F̅=α F̅+(1−α)ee^{T}/N (3)

This convex combination of the stochastic matrix and a stochastic perturbation matrix ee^{T} insures that F̅ is both stochastic and irreducible. Every node may now be directly connected to every other node, making the chain irreducible by definition. Although the transition probability may be very small in some cases, it is always nonzero. The irreducibility adjustment also ensures that F̅ is primitive, which implies that when n is large F̅⁽ⁿ⁾ may converge to the stationary distribution. By this definition, F̅ may be constructed as a primitive stochastic matrix to model the probabilities of information moving from one node to another. In our experiments (some described below), it was found that the results are insensitive to the value of α and set α=0.5. Thus, in at least one embodiment, the Early Adoption Based Information Flow (EABIF) Network may be generated using the irreducible Markov chain with F̅ as the transition probability matrix.

Now an exemplary approach for providing a Topic-Sensitive Early Adoption based Information Flow (TEABIF) Network will be described. As described above, people/entities may have different behavior patterns regarding different topics. For example, an early adopter of fashion may not be an early adopter of technology. Thus, it may be beneficial to utilize people's different social networks regarding different topics, for example, through email message patterns to model and predict human activities. Similarly, the same intuition may be followed to generate the topic-sensitive information flow networks use to provide, for example, recommendations. In our experimental examples herein, the items considered for topic analysis are documents available in a network (e.g., the Internet, an Intranet, on a single computer, etc.). The basic idea is that people/entities may tend to get information of certain topics earlier than others, while for some other topics, they may not be so eager to obtain the information. Thus, to get more accurate and consistent early/late behavior patterns, the documents may be clustered into latent topics and then the network(s) may be built based on how likely one user/entity is to access the document(s) regarding a certain topic earlier or later than the other users/entities.

A Latent Dirichlet Allocation approach may be adopted to generate the topics. Latent Dirichlet Allocation is a well-defined probabilistic generative model. (See, for example, D. Blei, A. Ng, and M. Jordan, Latent Dirichlet allocation, J. of Machine Learning Research, 3:993-1022, January 2003, hereby incorporated by reference.) It can be easily generalized to new documents and the number of parameters does not grow with the size of the training corpus. Thus, it is not prone to overfitting. Given T topics (T is determined by using cross-validation), the probability of the ith word in a given document is formularized as:

$$P ( {w}_{i} ) = {\sum }_{j = 1}^{T} P ( {w}_{i} \vert {z}_{i} = j ) P ( {z}_{i} = j ) \qquad ( 4 )$$

where zᵢ is a latent variable indicating the topic from which the ith word was drawn, and P(wᵢ|zᵢ=j) is the probability of the word wᵢ under the jth topic. P(zᵢ=j) gives the probability of choosing a word from topics j in the current document, which varies across different documents. Gibbs sampling (see, for example, T. Griffiths and M. Steyvers, “Finding Scientific Topics,” Proc. of the National Academy of Sciences, 5228-5235, 2004, hereby incorporated herein by reference) may be applied to estimate φⱼ^{(w)}, the probability of using word w in topic j, and θⱼ^{(d)}, the probability of topic j in document d. (See, for example, T. Valente. Network Models of the Diffusion of Innovations. Hampton Press, 1995, hereby incorporated herein by reference.)

After the topics are generated, each document may be clustered into a cluster j with a probability θⱼ^{(d)} with

$${\sum }_{j = 1}^{T} {θ}_{j}^{( d )} = 1.$$

Then for each cluster (topic), a topic adoption matrix as well as a weighted directed graph may be generated for all users. If, for example, User u accesses a document earlier than User v, and this document is clustered into Topic j with a probability of θⱼ^{(d)}, then this early adoption will contribute θⱼ^{(d)} to the unit (u,v) in the topic adoption matrix as well as the weight from u to v in the weighted graph. Then these T weighted network(s), with each one corresponding to a topic are used to generate Markov chains with a primitive stochastic matrix as the transition probability matrix F̅ᵢ is constructed for each topic i. Thus, these Markov chains may be used to make up the Topic-Sensitive Early Adoption Based Information Flow Network (TEABIF). Once the information flow networks have been constructed, attention is then directed to various ways to model the information propagation through the network.

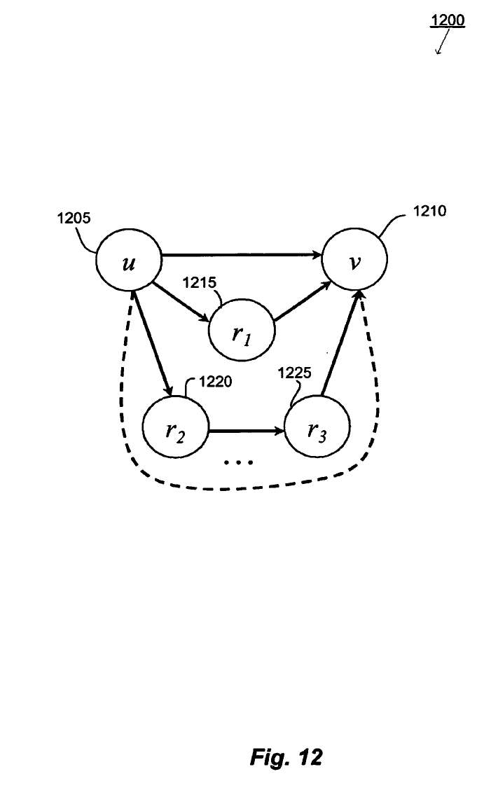

Referring now to FIG. 12, an exemplary illustration of information flow through multiple paths, according to at least one embodiment, is provided. Various information propagation models may be used for the present invention. Before discussing some exemplary information propagation models, an intuitive description of an information propagation approach 1200 will be provided with reference to FIG. 12. In the present invention information flow networks, the pairwise adoption patterns between users/entities/people are known. By one step calculation, people with highest transition probability from the current user/entity will be ranked as the most likely follower among all the users/entities. However, if we consider how information flows, it is possible that u 1205 obtains the information and spreads it to v 1210 directly, or the information may go through r₁ 1215 to v 1210, or through r₂ 1220, and r₃ 1225, to v 1210, or other paths (e.g., dotted line). Different from the traditional collaborative filtering technique which is solely based on pairwise similarity, the present information flow driven recommendation scheme utilizes how information propagates through multiple steps and paths to rank how likely it may be that user(s) adopt the information. The following analysis illustrates at least one technique as to how information flows through multiple steps and multiple paths using, for example, case studies.
1. The transition probability of the information flowing from u to v among all the users in one step is P(v=afᵤ|u=a), which is the transition probability from u to v, in our information flow networks.
2. The transition probability of the information flowing from u to v through two steps is

$${\sum }_{r} P ( r = {af}_{u} \vert u = a ) P ( v = {af}_{r} \vert r = a ) .$$

3. The transition probability of more steps has similar forms.

Assume pₖ being a distribution with Σₖpₖ=1 to be used for describing how likely each type of paths contributes to the overall information flow. Then the overall information flow (if) probability that the information will propagate from u to v among all users is equal to:

$${P}_{if} \text{(} v = {af}_{u} \vert u = a ) = {p}_{1} \cdot P \text{(} v = {af}_{u} \vert u = a ) + {p}_{2} \cdot {\sum }_{r} P \text{(} r = {af}_{u} \vert u = a ) P \text{(} v = {af}_{r} \vert r = a ) + … + {p}_{K - 1} \cdot {\sum }_{{r}_{1}} {\sum }_{⋯} {\sum }_{{r}_{K - 1}} P ( {r}_{1} = {af}_{u} \vert u = a ) … P ( v = {af}_{{r}_{K - 1}} \vert {r}_{K - 1} = a ) ) \qquad ( 5 )$$

where K is the maximum value of propagation steps.

Although there are a number of ways to calculate this probability, three exemplary approaches are described in detail herein. These may include the summation of various propagation steps, direct summation and exponential weighted summation. Some particular examples follow.

First, a summation of various propagation step approach will be explained. By equally considering various propagation steps, i.e., pₖ is a uniform distribution, Eq. (5) can be calculated as:

F_{if(m)}=( F̅+ F̅⁽²⁾+ . . . + F̅^{(m)})/m (6)

where m is the number of propagation steps. When m=1, F_{if(m)}= F̅ is a special case of Eq. (6) which only considers the pairwise relationship.

Another approach may be direct summation, which may utilize, for example, a von Neumann diffusion kernel. Considering pₖ being a uniform distribution and the maximum propagation steps in the network with N users being (N−1), Eq. (5) is equal to

F_{if(N-1)}=( F̅+ F̅⁽²⁾+ . . . + F̅^{(N-1)})/(N−1) (7)

which can be calculated as

$${F}_{if ( N - 1 )} = \frac{{F}^{\overline{\_}} \cdot ( I - {{F}^{\overline{\_}}}^{( N - 1 )} )}{I - {F}^{\overline{\_}}} \cdot \frac{1}{N - 1} \qquad ( 8 )$$

where I is a N×N unit matrix.

Assume the eigenvalues of matrix F̅ be λ₁, λ₂, . . . , λ_{N},

$$\begin{matrix}{{F}^{\overline{\_}}}^{( N )} = {[ U Λ {U}^{- 1} ]}^{( N )} \\ = U {Λ}^{( N )} {U}^{- 1} \\ = U [ \begin{matrix}{λ}_{1}^{( N )} & & & \\ & {λ}_{2}^{( N )} & & \\ & & ⋯ & \\ & & & {λ}_{N}^{( N )}\end{matrix} ] {U}^{- 1}\end{matrix} \qquad ( 9 )$$

As previously mentioned, F̅ may be a primitive stochastic matrix, which has only one eigenvalue on the unit circle, all other eigenvalues have modulus strictly less than one [24]: 1=λ₁>λ₂> . . . >λ_{N}. When the number of users/entities in the network (N) is large (>100), λᵢ^{N}≈0 for these λᵢ<1. This means that the exponentiation method applied to a primitive stochastic matrix F̅ is guaranteed to converge to the unique dominant eigenvector—the stationary distribution. As a result, there are no issues with convergence of the ranking vector, and any positive probability vector can be used to start the iterative process. Further, the convergence rate of the method is determined by the magnitude of the subdominant eigenvalue of the transition rate matrix. Thus, we have

$${{F}^{{ \_}^{ \_}}}^{( N )} = U [ \begin{matrix}1 & & & \\ & 0 & & \\ & & ⋯ & \\ & & & 0\end{matrix} ] {U}^{- 1} \qquad ( 10 )$$

After F̅^{(N-1)} is calculated by Equation (10) and insert into Equation (9), F_{if} is obtained. When N→∞, F_{if(d)}→F^{(N)}.

Another approach may be exponential weighted summation, which may utilize, for example, an Exponential Diffusion kernel. Usually short paths are more important for information propagation because their direct relationship to the users. Thus, it is worth considering assigning less importance to longer paths:

$${F}_{if ( exp )} = ( ( β {F}^{\overline{\_}} ) + \frac{1}{2 !} {( β {F}^{\overline{\_}} )}^{2} + … + \frac{1}{( N - 1 ) !} {( β {F}^{\overline{\_}} )}^{( N - 1 )} + … ) \cdot exp ( - β ) \qquad ( 11 )$$

where 1/N! assigns less importance to longer paths, β is a parameter to control the effects of transitivity. The larger β is, the longer paths are considered important. When β→∞, F_{if(exp)}→ F̅^{(N)}.

Also,

exp(β F̅)=I+(β F̅)+1/2!(β F̅)²+ . . . +1/(n−2)!(β F̅)^{(N-2)}+ (12)

### Therefore, F_{if(exp)}=(exp(β F̅)−I)·exp(−β). By using eigenvalue composition, exp(β F̅) can be calculated by

$$exp ( β {F}^{\overline{\_}} ) = U [ \begin{matrix}exp ( β ) & & & \\ & exp ( β {λ}_{2} ) & & \\ & & ⋯ & \\ & & & exp ( β {λ}_{N} )\end{matrix} ] {U}^{- 1} \qquad ( 13 )$$

Although these three exemplary propagation models have worked well with the following experimental results related to the application of providing recommendations, one skilled in the art would understand that variations of these propagation models and other propagation models may prove more advantageous with other applications of the present invention.

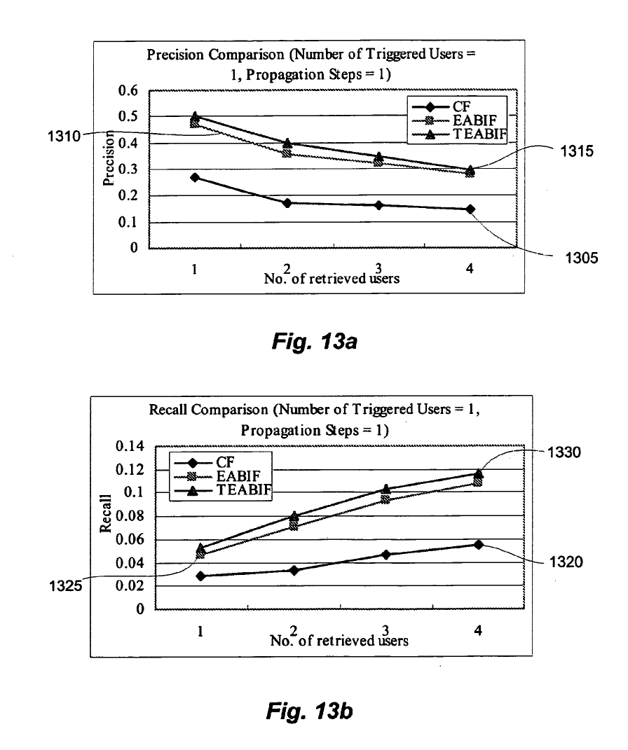

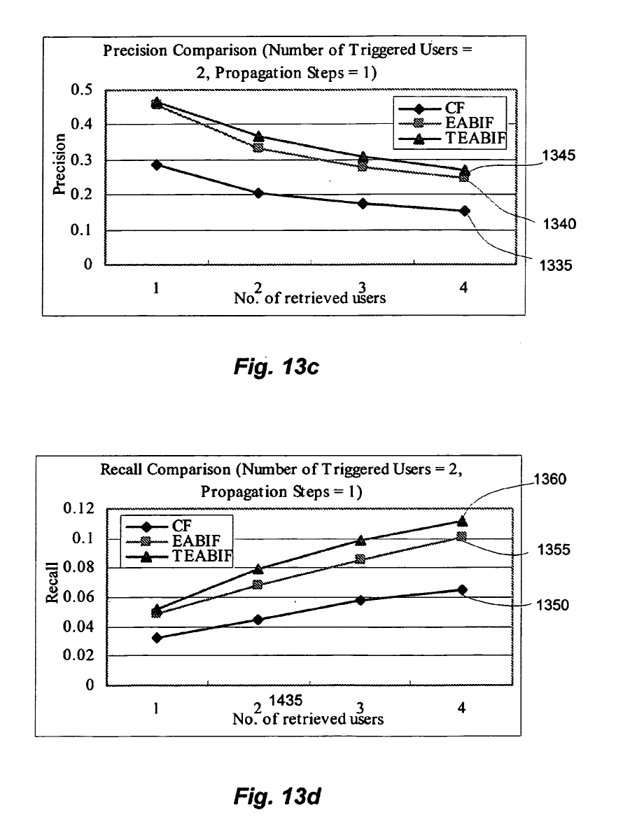

Referring now to FIGS. 13a-13d, exemplary comparison precision and recall for EABIF and TEABIF to baseline collaborative filtering results, according to at least one embodiment, are provided. For the experimental setup and proposed scheme, a dataset collected from NEC's “EigyoRyoku 21” (denoted as ER and stands for Sales-Force in Japanese) system was utilized. The ER system is a knowledgebase to support sales staffs with registered documents that include articles, slides, etc. A sixteen-month period of clickstream log files from April 2004 to July 2005 covering more than 30,000 users and 30,000 documents were collected. Nine user actions are identified: {“Login”, “Register_Feedback”, “Preview”, “Abstract”, “Document Download”, “Search”, “Register”, “Update”, “Delete”}. The clickstream log is partitioned into sessions that start with “login” and then sequences of user actions. The timestamps of users' actions as well as disclosure of the documents are included in the dataset. For simplification, it is assumed that if a user accesses (including “Preview”, “Abstract” or “Download”) a document, he or she has adopted it. In many applications, this assumption may accurately reflect reality.

The dataset is divided into two sets: the training set and the test set. The data from April 2004 to April 2005 serve as the training data, and the data from May to July 2005 serve as the test data. Among more than 30,000 users, approximately 20,000 of them only have no more than 10 adoption behaviors during the 16 months. That demonstrates the sparseness of the dataset. To exclude casual users who had very few activities, we selected 1170 active users who adopted more than 50 documents in the training period; and more than 10 documents in the test period in our experiments. In total, there are 23894 documents involved in this selected dataset. 201,750 adoption actions were recorded. The average number of adoption actions per user is 172, and the average number of actions per document is 8.

In the experiments, we simulate the situation of adoption behaviors. There are 586 documents disclosed during the test period from May to July 2005. The mean value of the number of users who adopted these 586 documents during May to July 2005 is 18. These documents were first adopted by one or multiple users—early adopters. Then we predict who else will most likely adopt the documents following these early adopters. Hence, instead of directly making document recommendations to users, we predict the potential adopters of each document. This strategy is suitable for online document/product pushing service or advertisement—recommending the items to potential customers according to the behaviors of early adopters. It can also be transferred to the traditional recommendation scenario by estimating how likely one user will be interested in the documents and recommending those top-ranked documents to him or her.

To evaluate the accuracy of predictions, we measure the precision and recall of the recommendations. Precision represents the ability of the system to withhold non-relevant users, which is measured as the proportion of recommended users who adopt the documents in the test period. Recall represents the ability of the algorithm to present all relevant users, which is measured as the proportion of the recommended users over all the users who adopted the documents in the test period. The values we report here are the respective average of the precisions and recalls for these 586 documents.

In our experiments, we compare the performance of the algorithms as following:
1. Collaborative Filtering based on Cosine Similarity (baseline)
2. Early adoption based information flow network with information propagation models
3. Topic sensitive information flow network with information propagation models

Specifically, for information propagation models, we will demonstrate the performances of propagation steps (m) from 1 to 5, direct summation, and exponential weighted summation.

The results of our experiments proved that the present invention will result in improved recommendations. First, it will be demonstrated that the recommendation quality of different algorithms when the propagation step is one. Then the performances of various information propagation models will be discussed.

First, it was determined that recommendation quality was improved by the present invention. In each experiment, we trigger an user, i.e., change his or her mode from inactive to active, who are the earliest to access a particular document, and then predict who else will also access this document by comparing the information propagation probabilities. FIGS. 13(a) and 13(b) compare the average precision and recall of Collaborative Filtering based on Cosine Similarity (labeled by CF), early adoption based information flow network (labeled by EABIF) and topic-sensitive early adoption based information flow network (labeled by TEABIF). The number of propagation steps equals to 1, in which only the pairwise information flow is considered. The recommendations are achieved by ranking the probabilities in the row which corresponds to how information flows from this triggered user to the others in the matrix F̅. Comparing to CF (1305), on average, EABIF (1310) is 91.0% better and TEABIF (1315) is 108.5% better in terms of precisions. Comparing to EABIF (1310), TEABIF (1315) improves 19.2% further. In terms of recalls, on average, EABIF (1325) is 87.1% better and TEABIF (1330) is 112.8% better than CF (1320). Comparing to EABIF (1325), TEABIF (1330) improves 29.5% further.

In a second experiment, we trigger users who are among the earliest two to access a particular document, and then predict who else will also likely access this document. Note the precisions and recalls cannot be directly compared to the results in the first experiments because the ground truth is different in these situations. For instance, there are totally ten users accessing one document in the test period, if we trigger one user, the other nine users are ground truth for recommendation. However, if we trigger two users, the other eight users are the ground truth.

By the “word-of-mouth” effects, each user's tendency to become active increases monotonically as more neighbors become active. The probability of one user will access the document among all the users is the summation of the according probabilities in the rows which are corresponding to how information flows from the triggered users to this user in the matrix F̅. Then the system recommends by ranking the probabilities of all users.

Referring now to FIGS. 13c and 13d, when two users serve as triggers we obtain the similar performance in the first experiment. On average, EABIF (1340) is 62.2% better than CF (1335), and TEABIF (1345) is 72.4% better than CF (1335) in terms of precision. Comparing to EABIF (1340), TEABIF (1345) improves 16.4% further. Comparing to CF (1350), on average, EABIF (1355) is 50.2% better; TEABIF (1360) is 66.8% better in terms of recall. Comparing to EABIF (1355), TEABIF (1360) improves 33.1% further.

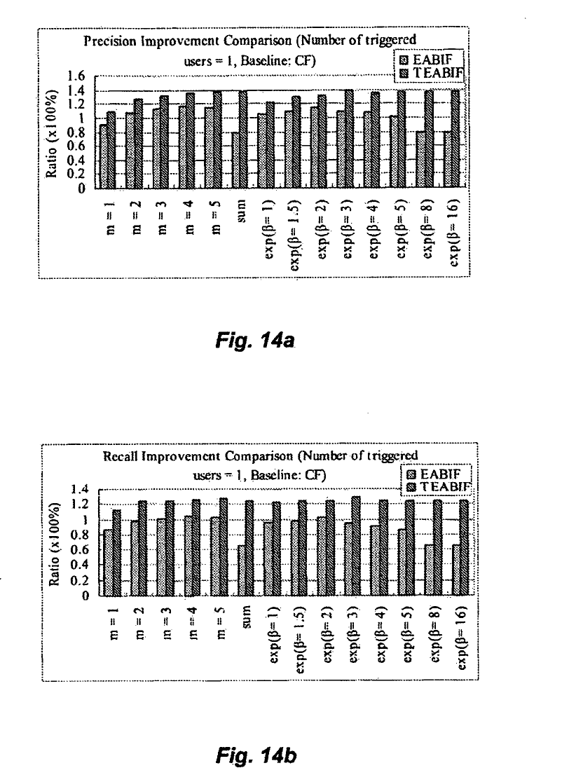

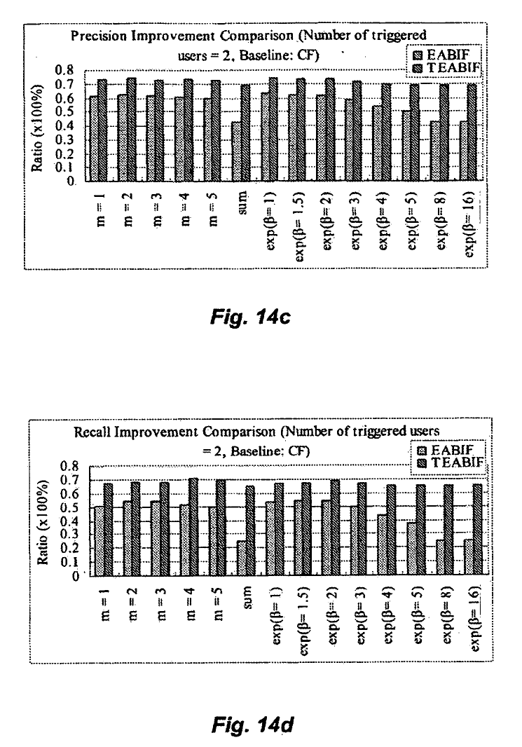

Referring now to FIGS. 14a-14d, exemplary comparison precision and recall for EABIF and TEABIF relative to collaborative filtering results with variation to the number of propagation steps, according to at least one embodiment, will be discussed. These results are indicative of improvements in propagation performance. Thus, the performance of different propagation models was further compare, including changing the number of propagation steps from 1 to 5 (labeled as m=1,2, . . . ,5), and using direct summation and exponential weighted summation when β=1,1.5,2, . . . ,5,8, and 16.

FIGS. 14a-14d compares the precision and recall improvement comparing to CF, i.e.,

$$\frac{{Performance}_{IF} - {Performance}_{CF}}{{Performance}_{CF}}$$

when the number of triggered users is one (FIGS. 14a and 14b) or two (FIGS. 14c and 14d). Among all propagation models, when the number of triggered users is one (FIGS. 14a and 14b), TEABIF with exponential weighted summation (β=3) achieves the best performance and improves 108.5% on precision and 116.9% on recall comparing to CF. Using the same propagation model (exponential weighted summation (β=3)), EABIF improves 91.0% in terms of precision, and 95.5% in terms of recall comparing to CF. Comparing to the number of propagation steps equals one, EABIF improves 25.3%, and TEABIF improves 28.3% in terms of precision; EABIF improves 17.1%, and TEABIF improves 9.8% in terms of recall.

When the number of triggered users equals to two, FIGS. 14c and 14d) compares the precision and recall improvement comparing to CF. Among all the propagation models, TEABIF with exponential summation with β=1 achieves the best precision. Comparing to CF, EABIF improves 69.1%, and TEABIF improves 81.1% in terms of precision; EABIF improves 54.5%, and TEABIF improves 69.4% in terms of recall. Comparing to the number of propagation steps equals one, EABIF improves 11.1%, and TEABIF improves 12.0% on precision; and EABIF improves 8.6%, TEABIF improves 5.4% on recall.

In FIGS. 14a-14d, EABIF with direct summation achieves the worst performance among all the propagation models we tested. However, the performance which TEABIF with direct summation achieves is much better than EABIF with direct summation even though it is not among the best performances. This phenomenon verifies again that users' adoption patterns are topic sensitive. An early adopter of one topic is not necessary to be the early adopter of another topic. Therefore, long-path propagation is not as effective for the topic-independent model—EABIF, as that of TEABIF which considers early adoption patterns regarding the same topic. The direct summation and exponential weighted summation when β≧8 have achieved the stationary distribution of the Markov chain.

Among all propagation models we have tested in FIGS. 14a-14d, TEABIF with m=4˜5 achieves similar performance to the best performance, which can serve as a simpler approximation to the more complex models.

The direct summation and the exponential summation with large β of all the paths with different lengths converge to the stationary distribution of the Markov chain. Long-path propagation is not as effective for the topic-independent model—EABIF, as that of TEABIF which considers early adoption patterns within the same topic. Overall, short-path propagations play more important roles than long-path propagations because the direct relationship among the users is more reliable.

Other experiments were performed using the present invention and applying it to the application of providing recommendations for movies that a user may like to see. Similar results were obtained.

In the present invention, various embodiments model user's adoption patterns as an information flow network, which may be applied in one application for a recommendation system. By comparing the timestamps when users access documents, an early adoption based information flow (EABIF) network is proposed. Furthermore, observing that adoption is typically category-specific, various embodiments of the present invention may include a topic-sensitive early adoption based information propagation (TEABIF) network, in which users' adoption patterns are clustered regarding the categories of the documents they accessed. Three information propagation models have also been described for various embodiments of the present invention, and one or more of them may be included to predict how specific information will propagate through the network, given known triggers. Thus the present invention provides system(s) and method(s) that may be applied to various applications, including providing recommendation(s). From the recommendation system perspective, the recommendation problem can be addressed as: once an item is adopted by one or more users, who else in the network will also likely to adopt it.

Various experiments indicate that the present invention improves the accuracy of the system(s) and method(s). For example, in experiments comparing to traditional Collaborative Filtering, EABIF with one-step propagation prediction improves 91.0% and 87.1%, and TEABIF with one-step propagation prediction improves 108.5% and 112.8% on precision and recall respectively. Furthermore, comparing to the one-step propagation prediction, EABIF with information propagation models improves 25.3% and 17.1%, and TEABIF with information propagation models improves 28.3% and 9.8% further on precision and recall respectively. When more users serve as the triggers, similar performance is achieved. In conclusion, the proposed system(s) and method(s) have demonstrated effective recommendation results.

As noted earlier, in at least one embodiment, the system(s) and method(s) provided herein may be implemented using a computing device, for example, a personal computer, a server, a mini-mainframe computer, and/or a mainframe computer, etc., programmed to execute a sequence of instructions that configure the computer to perform operations as described herein. In various embodiments, the computing device may be, for example, a personal computer available from any number of commercial manufacturers such as, for example, Dell Computer of Austin, Tex., running, for example, the Windows™ XP™ and Linux operating systems, and having a standard set of peripheral devices (e.g., keyboard, mouse, display, printer). FIG. 15 is a functional block diagram of one embodiment of a computing device 1500 that may be useful for hosting software application programs implementing the system(s) and method(s) described herein. Referring now to FIG. 15, the computing device 1500 may include a processing unit 1505, communications interface(s) 1510, storage device(s) 1515, a user interface 1520, operating system(s) instructions 1535, application executable instructions/API 1540, all provided in functional communication and may use, for example, a data bus 1550. The computing device 1500 may also include system memory 1555, data and data executable code 1565, software modules 1560, and interface port(s). The Interface Port(s) 1570 may be coupled to one or more input/output device(s) 1575, such as printers, scanner(s), all-in-one printer/scanner/fax machines, etc. The processing unit(s) 1505 may be one or more microprocessor(s) or microcontroller(s) configured to execute software instructions implementing the functions described herein. Application executable instructions/APIs 1540 and operating system instructions 1535 may be stored using computing device 1500 on the storage device(s) 1515 and/or system memory 1555 that may include volatile and nonvolatile memory. Application executable instructions/APIs 1540 may include software application programs implementing the present invention system(s) and method(s). Operating system instructions 1535 may include software instructions operable to control basic operation and control of the processor 1505. In one embodiment, operating system instructions 1535 may include, for example, the XP™ operating system available from Microsoft Corporation of Redmond, Wash.

Instructions may be read into a main memory from another computer-readable medium, such as a storage device. The term “computer-readable medium” as used herein may refer to any medium that participates in providing instructions to the processing unit 1505 for execution. Such a medium may take many forms, including, but not limited to, non-volatile media, volatile media, and transmission media. Non-volatile media may include, for example, optical or magnetic disks, thumb or jump drives, and storage devices. Volatile media may include dynamic memory such as a main memory or cache memory. Transmission media may include coaxial cable, copper wire, and fiber optics, including the connections that comprise the bus 1550. Transmission media may also take the form of acoustic or light waves, such as those generated during Radio Frequency (RF) and Infrared (IR) data communications. Common forms of computer-readable media include, for example, floppy disk, a flexible disk, hard disk, magnetic tape, any other magnetic medium, Universal Serial Bus (USB) memory stick™, a CD-ROM, DVD, any other optical medium, a RAM, a ROM, a PROM, an EPROM, a Flash EPROM, any other memory chip or cartridge, a carrier wave as described hereinafter, or any other medium from which a computer can read.

Various forms of computer-readable media may be involved in carrying one or more sequences of one or more instructions to the processing unit(s) 1505 for execution. For example, the instructions may be initially borne on a magnetic disk of a remote computer(s) 1585 (e.g., a server, a PC, a mainframe, etc.). The remote computer(s) 1585 may load the instructions into its dynamic memory and send the instructions over a one or more network interface(s) 1580 using, for example, a telephone line connected to a modem, which may be an analog, digital, DSL or cable modem. The network may be, for example, the Internet, and Intranet, a peer-to-peer network, etc. The computing device 1500 may send messages and receive data, including program code(s), through a network of other computer(s) via the communications interface 1510, which may be coupled through network interface(s) 1580. A server may transmit a requested code for an application program through the Internet for a downloaded application. The received code may be executed by the processing unit(s) 1505 as it is received, and/or stored in a storage device 1515 or other non-volatile storage 1555 for later execution. In this manner, the computing device 1500 may obtain an application code in the form of a carrier wave.

The present system(s) and method(s) may reside on a single computing device or platform 1500, or on multiple computing devices 1500, or different applications may reside on separate computing devices 1500. Application executable instructions/APIs 1540 and operating system instructions 1535 may be loaded into one or more allocated code segments of computing device 1500 volatile memory for runtime execution. In one embodiment, computing device 1500 may include system memory 1555, such as 512 MB of volatile memory and 80 GB of nonvolatile memory storage. In at least one embodiment, software portions of the present invention system(s) and method(s) may be implemented using, for example, C programming language source code instructions. Other embodiments are possible.

Application executable instructions/APIs 1540 may include one or more application program interfaces (APIs). The system(s) and method(s) of the present invention may use APIs 1540 for inter-process communication and to request and return inter-application function calls. For example, an API may be provided in conjunction with a database 1565 in order to facilitate the development of, for example, SQL scripts useful to cause the database to perform particular data storage or retrieval operations in accordance with the instructions specified in the script(s). In general, APIs may be used to facilitate development of application programs which are programmed to accomplish some of the functions described herein.

The communications interface(s) 1510 may provide the computing device 1500 the capability to transmit and receive information over the Internet, including but not limited to electronic mail, HTML or XML pages, and file transfer capabilities. To this end, the communications interface 1510 may further include a web browser such as, but not limited to, Microsoft Internet Explorer™ provided by Microsoft Corporation. The user interface(s) 1520 may include a computer terminal display, keyboard, and mouse device. One or more Graphical User Interfaces (GUIs) also may be included to provide for display and manipulation of data contained in interactive HTML or XML pages.

Referring now to FIG. 16, a network 1600 upon which the system(s) and method(s) may operate, is illustrated. As noted above, the system(s) and method(s) of the present patent application may be operational on one or more computer(s). The network 1600 may include one or more client(s) 1605 coupled to one or more client data store(s) 1610. The one or more client(s) may be coupled through a communication network (e.g., fiber optics, telephone lines, wireless, etc.) to the communication framework 1630. The communication framework 230 may be, for example, the Internet, and Intranet, a peer-to-peer network, a LAN, an ad hoc computer-to-computer network, etc. The network 1600 may also include one or more server(s) 1615 coupled to the communication framework 1630 and coupled to a server data store(s) 1620. The present invention system(s) and method(s) may also have portions that are operative on one or more of the components in the network 1600 so as to operate as a complete operative system(s) and method(s).

While embodiments of the invention have been described above, it is evident that many alternatives, modifications and variations will be apparent to those skilled in the art. In general, embodiments may relate to the automation of these and other business processes in which analysis of data is performed. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

We claim:

1. A method of capturing user behavior, comprising the step of:
generating an influence network including users' adoption behavior of items.

2. The method of claim 1, wherein the influence network further includes time.

3. The method of claim 2, wherein the influence network further includes adoption times of items between users.

4. The method of claim 1, further comprising the step of identifying information propagation through the influence network.

5. The method of claim 1, wherein the influence network includes category of items.

6. The method of claim 1, wherein the influence network includes asymmetric users' adoption behavior.

7. A method of influence filtering (collaborative filtering directed claim), comprising the steps of:
generating asymmetric relationship(s) between users; and
providing a filtering module utilizing the asymmetric relationship(s) between users.

8. The method of claim 7, wherein the influence filtering is for ranking users and/or items.

9. The method of claim 7, wherein the asymmetric relationship is the user adoption of items between users.

10. The method of claim 7, wherein the influence filtering includes category of items.

11. The method of claim 7, wherein the influence filtering further includes time.

12. A method of using behavior patterns drawn from data, comprising the steps of:
generating an influence network including user adoption behavior for items of interest that comprehends time of adoption; and
determining asymmetric influence between users of the network.

13. The method of claim 12, further comprising the step of providing one or more recommendation(s) to at least one user or entity based on the asymmetric influence between users or entities.

14. The method of claim 12, further comprising the step of determining if the behavior patterns are topic sensitive.

15. The method of claim 12, further comprising the step of sorting the data by category.

16. The method of claim 12, further comprising the step of analyzing historical data from a dataset found in one or more databases.

17. The method of claim 12, wherein the influence network is a mutli-node and multi-path information flow network that includes quantified asymmetric user/entity behavior between various nodes of the network.

18. The method of claim 12, further comprising the steps of:
determining if data has been accessed by a user or a recommendation has been requested; and
providing a recommendation to the user based on an item selected and information flow through the network based on the asymmetric influences between users.

19. The method of claim 18, further comprising the steps of:
determining if an item is adopted by a user; and
updating data in the one or more database(s) to record the adoption of an item by the user.

20. A computer system configured for using behavior patterns drawn from data, comprising:
a first modeling module modeling asymmetric influences between users; and
a second modeling module modeling information propagation that considers time in determining asymmetric influence between the users.

21. The system of claim 20, further comprising:
one or more databases with data identifiers including a user ID, an item ID, and a time stamp.

22. The system of claim 21, further comprising a recommendation module.

23. The system of claim 20, wherein the first modeling module includes an early adoption based information flow network.

24. The system of claim 23, wherein the first modeling module includes a topic sensitive early adoption based information flow network.

25. The system of claim 20, wherein the first modeling module includes a topic sensitive early adoption based information flow network.

26. The system of claim 20, wherein the second modeling module uses summation of various propagation steps to model information propagation.

27. The system of claim 20, wherein the second modeling module uses direct summation to model information propagation.

28. The system of claim 20, wherein the second modeling module uses exponential weighted summation to model information propagation.
